(19) United States
(12) Patent Application Publication
(10) Pub. No.: US 2003/0157010 A1
(43) Pub. Date: Aug. 21, 2003

(54) Method for the catalytic conversion of gases with a high sulfur dioxide content

(76) Inventors: Nikola Anastasijevic, Altenstadt (DE); Dietrich Werner, Messel (DE); Marcus Runkel, Partenheim (DE); Stefan Laibach, Frankfurt/Main (DE); Egon Winkler, Florsheim (DE); Achim Hollnagel, Frankfurt/Main (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/275,935

(22) PCT Filed: Apr. 20, 2001
(86) PCT No.: PCT/EP01/04503

(30) Foreign Application Priority Data
May 11, 2000 (DE) 100 23 178.0

(51) Int. Cl. B01D 53/50

(52) U.S. Cl. 423/244.02

(57) ABSTRACT

A gas mixture comprising molecular oxygen and 15 to 60 vol-% SO₂ flows through a first catalyst layer which contains a catalyst containing vanadium pentoxide, and directly subsequently through a second catalyst layer which contains a catalyst containing iron. With an inlet temperature of 350 to 600° C., the gas mixture is introduced into the first catalyst layer which contains a granular V₂O₅ catalyst and 20 to 80 wt-% catalytically inactive inert material. Directly subsequently, the gas mixture is introduced into the second catalyst layer with a temperature of 500 to 750° C. Preferably, the catalyst of the second catalyst layer contains 3 to 30 wt-% arsenic oxide. There is produced an SO₃-containing product gas with a volume ratio of SO₂: SO₃ of not more than 0.1.

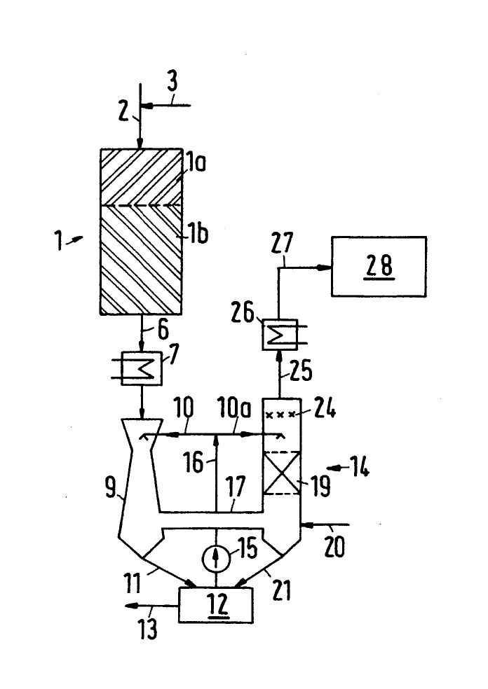

### DESCRIPTION

This invention relates to a process for the catalytic conversion of a gas mixture which contains oxygen and 15 to 60 vol-% SO₂ at temperatures in the range from 350 to 800° C. when flowing through a first catalyst layer which contains a catalyst containing vanadium pentoxide, and directly subsequently through a second catalyst layer which contains a catalyst containing iron, for producing a product gas containing SO₃ with a volume ratio of SO₂ to SO₃ of not more than 0.1. The product gas containing SO₃ can be processed to obtain sulfuric acid in a conventional way.

A high SO₂ content in the gas mixture to be converted leads to a high increase in temperature at the catalyst, as the SO₂ oxidation is a strongly exothermal reaction. The conventional vanadium-based catalysts are thermally unstable at the resulting high temperatures, so that usually SO₂ concentrations of only about 10 to 12 vol-% are admitted.

To be able to also process gases with a higher SO₂ content, it is proposed in DE-AS 2213580 to perform the conversion first in part on a V₂O₅ catalyst and then pass the gas through a bed of an iron oxide catalyst without intermediate cooling. Upon cooling, the gas should then be passed through at least one further catalyst bed. This process is relatively complex. The process described in DE 198 00 800 A1 employs a special, thermally stable iron catalyst, before which a vanadium-containing ignition layer may be provided.

It is the object underlying the invention to develop the known processes and provide an inexpensive process which in practice operates in a robust way. In particular, the catalysts should exhibit a thermally stable behavior and also be insensible to impurities in the gas.

In accordance with the invention, this object is solved in the above-mentioned process in that the gas mixture is introduced into the first catalyst layer with an inlet temperature of 350 to 600° C., that the first catalyst layer contains granular V₂O₅ catalyst and 20 to 80 wt-% catalytically inactive inert material, and that the gas mixture is introduced into the second catalyst layer with a temperature of 500 to 750° C.

In the process in accordance with the invention, a catalyst of weakened activity, e.g. a dilute catalyst, is employed in the first catalyst layer, whereby the increase in temperature is limited. The catalytically inactive inert material important for this purpose may be present in the catalyst bed as inert packing bodies (e.g. on the basis of SiO₂), or it may already be integrated in the catalyst grains. The gas leaving this first catalyst layer enters the second catalyst layer directly and without intermediate cooling with a temperature of 500 to 750° C. and preferably 550 to 680° C.

The catalyst of the second catalyst layer has a carrier on the basis of SiO₂, which exhibits an inert behavior, and based on the total mass of the catalyst it contains 3 to 30 wt-% iron oxide and 3 to 30 wt-% arsenic oxide (As₂O₃) as active components. For the constancy of the activity it is advantageous when at least 20 wt-% and preferably at least 40 wt-% of the arsenic oxide are bound as iron arsenate (FeAsO₄).

It was found that arsenic is an important active component which stabilizes the active mass of the iron-containing catalyst and also wholly or largely prevents the disadvantageous crystal growth of Fe₂O₃. For a constantly high conversion of SO₂ to SO₃ in a continuous operation with sufficient O₂ it is advantageous when a certain amount of iron in the catalyst of the second catalyst layer is bound in an amorphous structure, e.g. at least 10% of the iron. This amorphous structure consists of various iron oxide and sulfate phases.

The iron-containing catalyst to be used in accordance with the invention contains arsenic and thereby is also insensible to a high arsenic content in the gas to be processed. This is important for practical purposes, as on the other commonly used catalysts arsenic acts as catalyst poison and deteriorates their activity in the long run.

### EXAMPLE

In the laboratory, there were first of all produced variants A and B of an iron-containing catalyst:

As starting material, there is used a commercially available SiO₂ catalyst carrier material (manufacturer: BASF) in tubular shape with an outside diameter of 10 mm and with lengths in the range from 10 to 20 mm. It has a good thermal stability up to 1000° C. and a BET surface of about 1000 m²/g. The decrease in pressure of the bed of carrier material is 2 to 3 mbar per m bulk height. The composition of the catalysts can be taken from Table 2 below.

Catalyst A (without arsenic):

30 g of the SiO₂ carrier are added to a solution of 5.08 g Fe₂(SO₄)₃ in 100 ml water. After 10 minutes exposure time with occasional shaking of the container, the carrier material is removed from the solution and dried in a drying cabinet for 3 hours at 105° C. This impregnation process is repeated 3 times.

Catalyst B (with arsenic):

First of all, there is prepared a solution of 6 g Fe₂(SO₄)₃ in 200 ml water. By adding 4 g As₂O₅, iron arsenate is precipitated. 50 g of the SiO₂ carrier are subsequently impregnated in the suspension for 10 minutes by occasionally shaking the container. The carrier material is then dried in a drying cabinet for 3 hours at 105° C., the impregnation process is repeated 5 times, until the entire suspension is consumed.

### Example 1

In the laboratory, catalysts A and B were tested:

As test reactor a quartz glass reactor was used. With a bulk density of 0.35 g/m³, the reactor was filled up to a bulk height of 2 times the inside diameter d of the quartz glass reactor. A thermocouple was disposed in the middle of the catalyst bed with a distance from the gas inlet of 0.15 d. The gas supply of SO₂, O₂ and N₂ was effected via 3 mass flow controllers. Behind a gas mixing chamber, the gas was heated at the outer shell of the reactor and flowed through the catalyst bed from below. At the reactor outlet, the gas was guided at room temperature via three sulfuric acid wash bottles to the SO₃ absorption and thereafter through gas analyzers for O₂ and SO₂.

For all tests, the dwell time was constant. This resulted in a volume flow of 68 1/h. The composition of the inlet gas was 20 vol-% SO₂, 16 vol-% O₂, and 64 vol-% N₂. At the beginning of the test, a temperature profile of 500 to 750° C. was recorded. For a test period of 5 days, the course of the SO₂ conversion at 750° C. was determined. Subsequently, the catalyst was examined for its chemical composition (X-ray fluorescence analysis) and its phase constituents (X-ray diffractometer analysis); the results are shown in Table 1.

TABLE 1

| Catalyst | C | Temperature |
|---|---|---|
| A | 90% | 750° C. |
| B | 6.5% | 750° C. |
| B1 | 1.0% | 600 to 700° C. |

C = degree of crystallinity of Fe₂O₃,
B1 = the catalyst used in Example 2 below.

### Example 2

In a pilot plant, a commercially available vanadium catalyst V1 together with 50 wt-% inert packing bodies (SiO₂ tubes) formed the first catalyst layer, the second catalyst layer consisted of catalyst B, which in the course of operation was changed into catalyst B1 by absorbing arsenic.

The tests were performed in a modular pilot plant, which for this purpose was set up in a metallurgical plant, in order to test under real conditions. A partial stream of the dedusted raw gas was cooled in a jet scrubber and subsequently dried, before it was supplied to the reactor after being preheated to 350° C. The gas flow rate was 200 Nm³/h, the gas was composed of 20 vol-% SO₂, 16 vol-% O₂, and 64 vol-% N₂.

Due to the dilution of the vanadium catalyst with packing bodies, the activity of the ignition layer could be decreased sufficiently, in order to keep the outlet temperature of the gas from the first catalyst layer at 610° C. In the second catalyst layer, the iron oxide catalyst used was active at a temperature in the range from 600 to 750° C. During operation, arsenic from the exhaust gas accumulated in the catalyst and formed iron arsenate.

The main components of the various catalysts can be taken from Table 2 below (in wt-%):

TABLE 2

| Catalyst | SiO₂ | V₂O₅ | Fe₂O₃ | As₂O₃ | Al₂O₃ |
|---|---|---|---|---|---|
| A | 92.0 | — | 4.1 | — | — |
| B | 90.8 | — | 3.05 | 5.4 | 0.42 |
| B1 | 68.4 | 0.45 | 13.6 | 3.87 | 0.38 |
| V1 | 56.1 | 4.6 | 1.21 | 0.66 | 1.42 |

The drawing shows a flow diagram of the process in the application together with a conventional sulfuric acid plant.

Gas rich in SO₂, to which O₂-containing gas (e.g. air enriched with O₂) has been admixed through line (3), is supplied to an initial stage (1) through line (2). The SO₂ content of the gas in line (2) lies in the range from 15 to 60 vol-% and mostly is at least 18 vol-%, the gas has preferably been preheated to temperatures of 350 to 600° C. The initial stage (1) comprises the first catalyst layer (1a) and the second catalyst layer (1b).

At the entry to layer (1a), a volume ratio Of O₂: SO₂ of at least 1:2 is ensured. A first SO₃-containing product mixture leaves layer (1b) in line (6) with temperatures in the range from 600 to 800° C. and preferably 620 to 750° C. In the waste heat boiler (7), this first mixture is cooled to temperatures of 50 to 300° C., whereby valuable high-pressure steam can be recovered from cooling water. The gas mixture then enters a first absorber (9), which is designed e.g. similar to a Venturi scrubber. Sulfuric acid coming from line (10) is sprayed into the gas, the concentration of the sulfuric acid being increased due to the absorption of SO₃. The sulfuric acid formed in the first absorber (9) flows through line (11) to a collecting tank (12), the excess sulfuric acid, whose concentration usually lies in the range from 95 to 100 wt-%, is withdrawn via line (13).

From the collecting tank (12), sulfuric acid is passed through the circulating pump (15) and line (16) to the first absorber (9) and also to a second absorber (14), which is connected with the first absorber by the passage (17). SO₃-containing gas flows through the passage (17) to the second absorber (14) and then upwards through a layer (19) of contact elements, which layer is sprayed with sulfuric acid from line (10a). Water is supplied via line (20), and the sulfuric acid discharged via line (21) likewise reaches the collecting tank (12). In practice, the absorbers (9) and (14) may also be designed other than represented in the drawing.

The gas flowing upwards in the second absorber (14) releases sulfuric acid droplets in the droplet separator (24) and then flows through line (25) to a heater (26), which raises the temperature of the gas to 380 to 500° C. The gas in line (27), which here is also referred to as second product mixture, usually has an SO₂ concentration of 3 to 14 vol-%. Due to this relatively low SO₂ concentration, it may be fed into a conventional sulfuric acid plant (28), which employs usual catalysts for oxidizing SO₂ to obtain SO₃. The mode of operation and the structure of such conventional plant is known and described for instance in Ullmann's Encyclopedia of Industrial Chemistry, 5th edition, vol. A25, pages 644 to 664.

1. A process for the catalytic conversion of a gas mixture which contains molecular oxygen and 15 to 60 vol-% SO₂ at temperatures in the range from 350 to 800° C. when flowing through a first catalyst layer which contains a catalyst containing vanadium pentoxide, and directly subsequently through a second catalyst layer which contains a catalyst containing iron, for producing an SO₃-containing product gas with a volume ratio of SO₂:SO₃ of not more than 0.1, characterized in that the gas mixture is introduced into the first catalyst layer with an inlet temperature of 350 to 600° C., that the first catalyst layer contains granular V₂O₅ catalyst and 20 to 80 wt-% catalytically inactive inert material, and that the gas mixture is introduced into the second catalyst layer with a temperature of 500 to 750° C.

2. The process as claimed in claim 1, characterized in that the catalyst of the second catalyst layer comprises an SiO₂ carrier and contains 3 to 30 wt-% iron oxide and 3 to 30 wt-% arsenic oxide, based on the total mass of the catalyst.

3. The process as claimed in claim 2, characterized in that the iron in the catalyst of the second catalyst layer is bound in an amorphous structure for at least 10 wt-%.

4. The process as claimed in claim 1 or any of the preceding claims, characterized in that the SO₃-containing product gas withdrawn from the second catalyst layer is brought in contact with sulfuric acid for removing SO₃, whereby a gas mixture with an SO₃ content of 3 to 30 vol-% is produced, from which sulfuric acid is produced.
